(19) United States
(12) Patent Application Publication
(10) Pub. No.: US 2016/0286018 A1
(43) Pub. Date: Sep. 29, 2016

(54) COMMUNICATION DEVICE FOR SMARTWATCH

(71) Applicant: Wen-Sung Lee, Taichung (TW)

(72) Inventor: Wen-Sung Lee, Taichung (TW)

(21) Appl. No.: 14/664,927

(22) Filed: Mar. 23, 2015

(51) Int. Cl. H04M 1/60

(52) U.S. Cl. CPC H04M 1/6058; H04B 2001/3872

(57) ABSTRACT

A smartwatch includes a display device connected to the thereof, and a communication device and a circuit board are respectively located in the body. The communication device has a speaking unit and a receiving unit. A watchband is connected to the body and a scrolling unit is located in the body. The scrolling unit has a mandrel and a wire which is wrapped to the mandrel. Two ends of the wire are respectively connected to the speaking unit and the circuit board. A clip member is connected to the speaking unit so that the user clips the clip member and pulls the wire out to move the speaking unit close to the user's ear.

### BACKGROUND OF THE INVENTION

1. Fields of the Invention

The present invention relates to a communication device for a smartwatch, and more particularly, to a communication device that is able to be extended from the smartwatch and located close to the users' ear.

2. Descriptions of Related Art

The conventional smartwatches are designed to combine multiple functions which usually are performed by different individual products, such as a watch and a smartphone. The smartphone is used to communicate with other peoples by audio signals, and the watch shows time on the dial. It is noted that when using the smartphone to take to a friend, the user has to hold the smartphone close to his/her ear, however, when checking time by watching the dial, the smartphone does not need to move toward the ear. In other words, these two functions are operated by different ways. When using the smartwatch to take an incoming call, the user has to move the smartwatch close to the ear, or the user has to put the incoming call on the microphone. It is weird to raise the arm to move the smartwatch to the ear and talk, and it is still weird if the incoming call is put on the microphone and everyone around can hear the incoming call.

Although the Bluetooth function can transfer the incoming call to the ear set so that the user does not need to move the smartwatch to the ear, nevertheless, it requires an extra product, such as the ear set, and cost.

The present invention intends to provide a communication device for a smartwatch so as to eliminate the shortcomings mentioned above.

### SUMMARY OF THE INVENTION

The present invention relates to a smartwatch and comprises a display device, a communication device and a circuit board, wherein the display device, the communication device and the circuit board are electronically connected to each other. The communication device has a speaking unit and a receiving unit. A body has a room defined therein, and a watchband is connected to the body. The display device is connected to the body. The communication device and the circuit board are located in the room. A scrolling unit is located in the room and has a mandrel and a wire which is wrapped to the mandrel. Two ends of the wire are respectively connected to the speaking unit and the circuit board.

The primary object of the present invention is to provide a smartwatch which has a communication device, the communication device includes a speaking unit and a receiving unit. The speaking unit is connected with a wire which is scrolled in the smartwatch, the user pulls the wire to move the speaking unit close to his/her ear so the smartwatch does not need to move to a higher position.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the smartwatch of the present invention;

FIG. 2 shows that the wire with the speaking unit are pulled out from the body of the smartwatch of the present invention;

FIG. 3A is an end cross sectional view of the smartwatch of the present invention;

FIG. 3B is a side cross sectional view of the smartwatch of the present invention;

FIG. 4 shows that a user pulls the wire to move the speaking unit toward the user's ear;

FIG. 5 is a perspective view to show the second embodiment of the smartwatch of the present invention;

FIG. 6 is a side cross sectional view of the smartwatch of the present invention in FIG. 5, and

FIG. 7 shows that a user pulls the telescopic member to move the speaking unit toward the user's ear.

### DETAILED DESCRIPTION OF THE PREFERRED EMBODIMENT

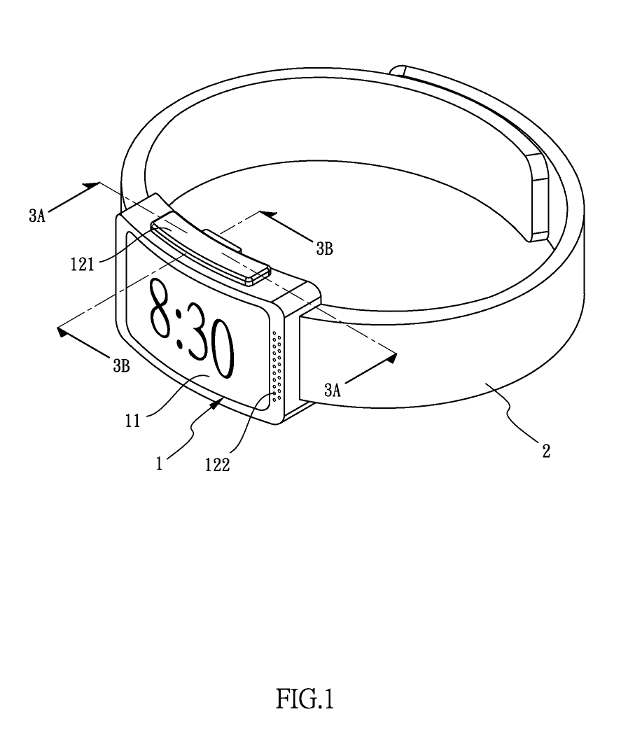

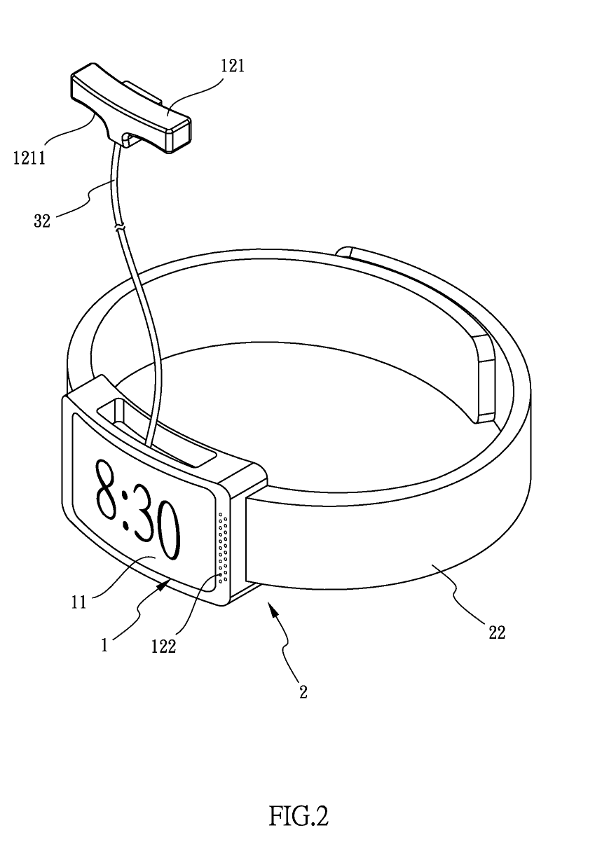

Referring to FIGS. 1 to 4, the smartwatch 1 of the present invention comprises body 2 which has a display device 11 and a watchband 22 respectively connected thereto. The body 2 has a room 21 defined therein, and a communication device 12 and a circuit board 13 are located in the room 21. The display device 11, the communication device 12 and the circuit board 13 are electronically connected to each other. The communication device 12 has a speaking unit 121 and a receiving unit 122.

A scrolling unit 3 is located in the room 21 and has a mandrel 31, and a wire 32 is wrapped to the mandrel 31. The mandrel 31 has a scrolling spring 33 received therein so as to scroll the wire 32 to the mandrel 31. Two ends of the wire 32 are respectively connected to the speaking unit 121 and the circuit board 13. The speaking unit 121 includes a clip member 1211 such that the user can hold the clip member 1211 to use the speaking unit 121. In this embodiment, the clip member 1211 is a T-shaped member and has a protrusion on one side thereof so that the user's fingers clip the protrusion to pull the wire 32 from the body 2. When not in use, the scrolling spring 33 position the clip member 1211 to be positioned onto the body 2.

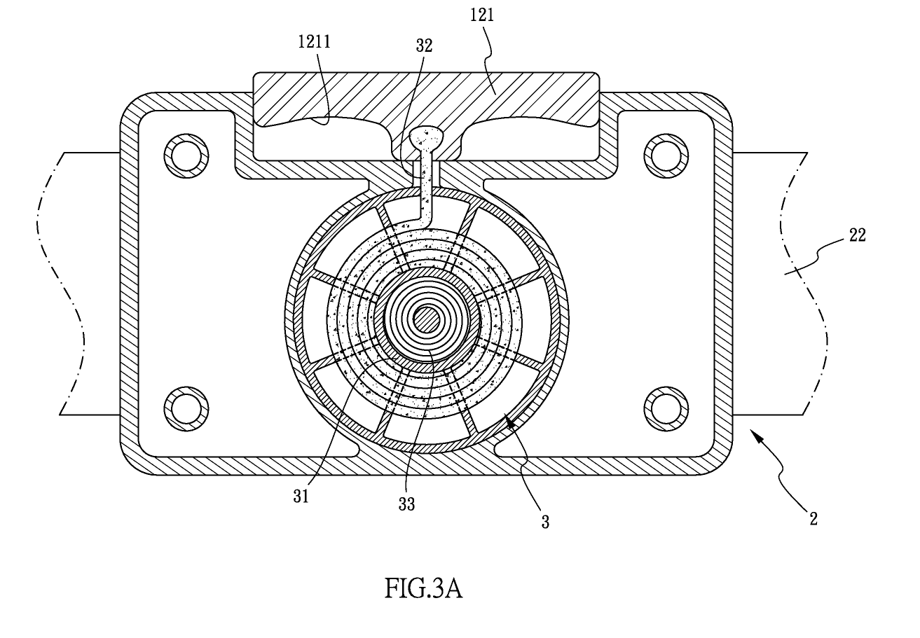

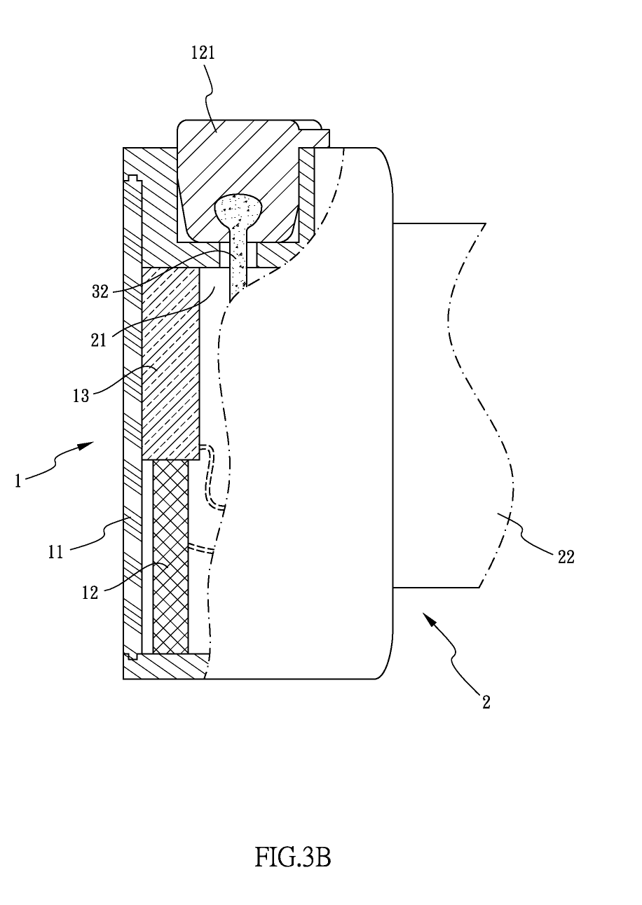

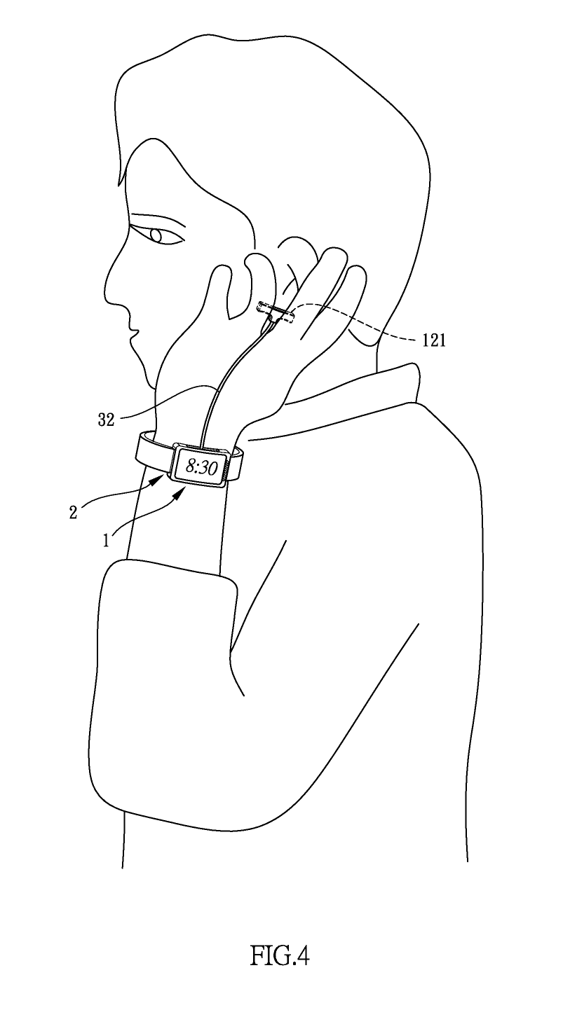

As shown in FIGS. 3 and 4, when using the smartwatch 1, the watchband 22 positions the smartwatch 1 to the user's arm, and the communication device 12 is able to receive incoming calls and displays the related information on the display device 11. When an incoming call comes in, the user clips the clip member 1211 and pulls the wire 32 toward his/her ear to take the incoming call. When finishing the incoming call, the wire 32 is released, and the scrolling spring 33 scrolls the wire 32 backward to the mandrel 31, the clip member 1211 is re-positioned to the body 2.

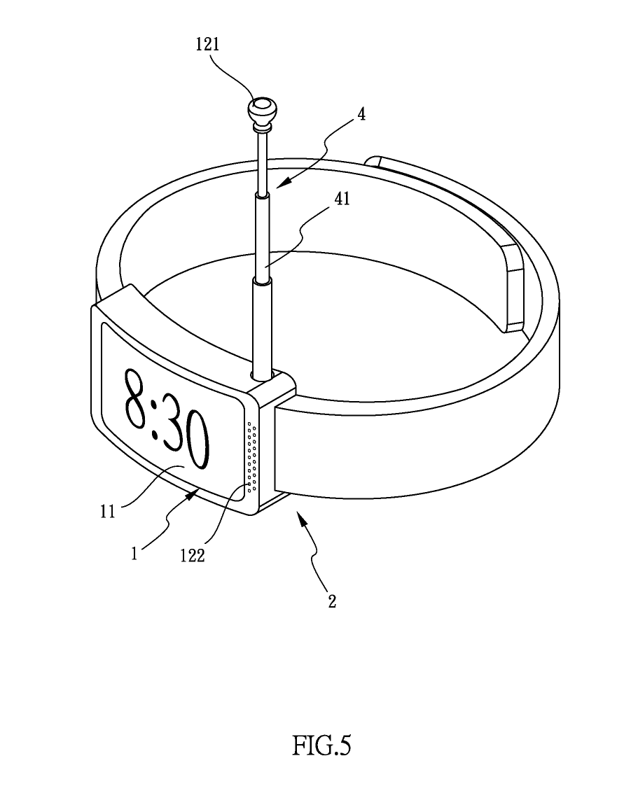

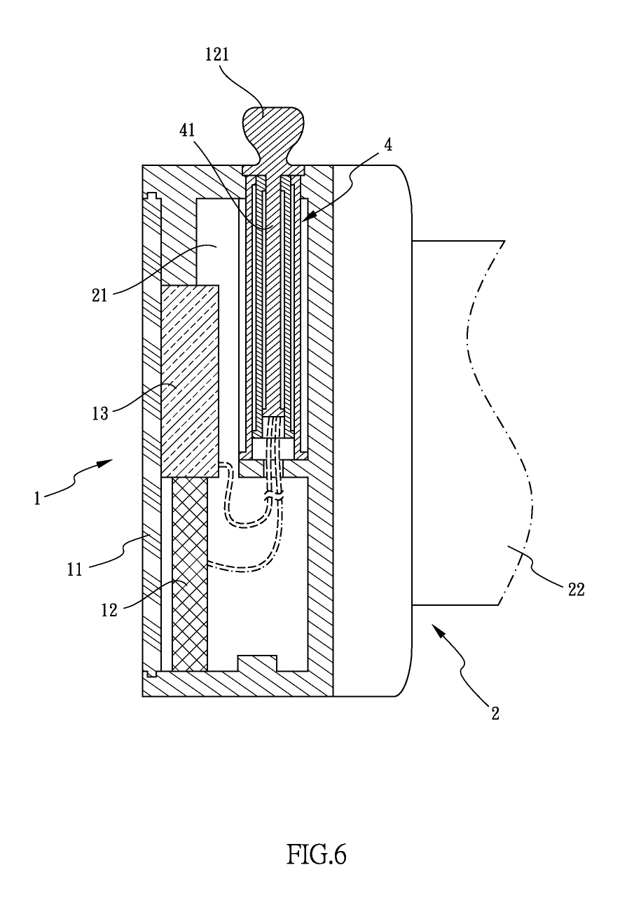

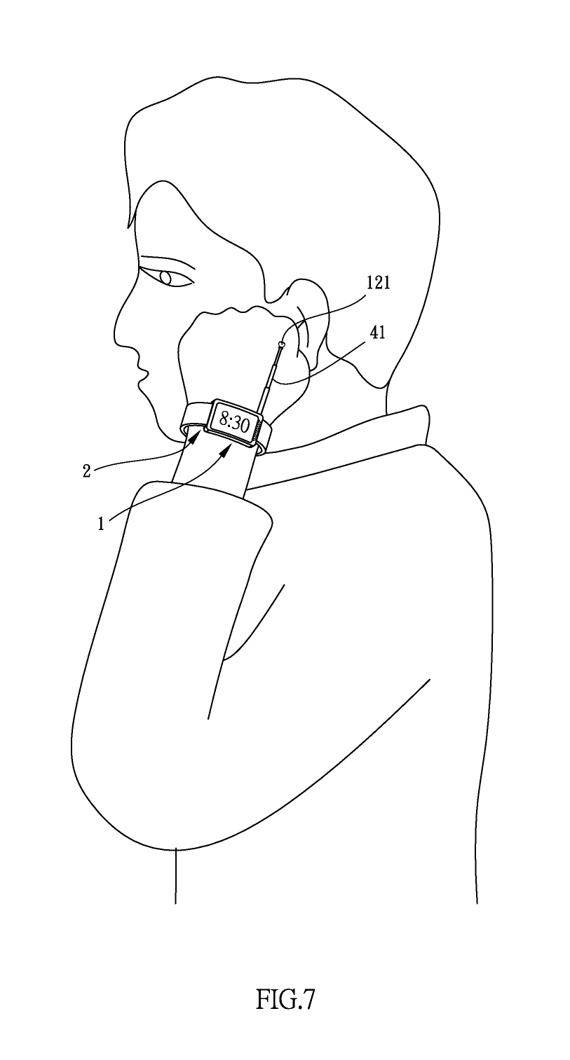

FIGS. 5 to 7 show the second embodiment of the present invention wherein the difference from the first embodiment is that the scrolling unit 3 including the mandrel 31 and the wire 32, and the clip member 1211 are replaced by a telescopic unit 4 which located in the room 21 and has a telescopic member 41. Two ends of the telescopic member 41 are respectively connected to the speaking unit 121 and the circuit board 13. The telescopic member 41 can be retracted to the position as shown in FIG. 6 when the telescopic member 41 is not in use. As shown in FIG. 7, when taking an incoming call, the telescopic member 41 is pulled outward so that the speaking unit 121 on the telescopic member 41 is located close to the user's ear. Therefore, the user's arm does not need to move to a higher position.

The present invention provides the wire 32 or the telescopic member 41 to the smartwatch 1, and the speaking unit 121 is connected to wire 32 or the telescopic member 41 so that the user does not have to raise his/her arm to the height to reach the ear when taking incoming calls.

While we have shown and described the embodiment in accordance with the present invention, it should be clear to those skilled in the art that further embodiments may be made without departing from the scope of the present invention.

1. A smartwatch comprising:
a display device, a communication device and a circuit board, the display device, the communication device and the circuit board being electronically connected to each other, the communication device having a speaking unit and a receiving unit, and
a body having a room defined therein, a watchband connected to the body, the display device connected to the body, the communication device and the circuit board located in the room, a scrolling unit located in the room and having a mandrel and a wire which is wrapped to the mandrel, two ends of the wire respectively connected to the speaking unit and the circuit board;
wherein the speaking unit includes a clip member which is adapted to be held by user's fingers.

2. (canceled)

3. The smartwatch as claimed in claim 1, wherein the mandrel has a scrolling spring received therein so as to scroll the wire to the mandrel.

4. A smartwatch comprising:
a display device, a communication device and a circuit board, the display device, the communication device and the circuit board being electronically connected to each other, the communication device having a speaking unit and a receiving unit, and
a body having a room defined therein, a watchband connected to the body, the display device connected to the body, the communication device and the circuit board located in the room, a telescopic unit located in the room and having a telescopic member, two ends of the telescopic member respectively connected to the speaking unit and the circuit board.
